(19) United States
(12) Patent Application Publication
(10) Pub. No.: US 2010/0289671 A1
(43) Pub. Date: Nov. 18, 2010

(54) AIRCRAFT VIEWING SYSTEM

(75) Inventors: Pierre HAUTY, Toulouse (FR); Jean-Louis BIGOT, Blagnac (FR); Helene TRIBUT, Beauzelle (FR); Jean-Luc VIALATTE, Toulouse (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Airbus France, Toulouse (FR)

(21) Appl. No.: 11/940,675

(22) Filed: Nov. 15, 2007

(30) Foreign Application Priority Data
Nov. 24, 2006 (FR) 06 55089

(51) Int. Cl. G08B 21/00

(52) U.S. Cl. 340/945

(57) ABSTRACT

This invention relates to an aircraft viewing system comprising:
a plurality of generation devices (330₁, . . . , 330_{k;} 730₁, . . . , 730_{k;} 830₁, . . . , 830ₖ) adapted to generate video flows from aircraft data;
a plurality of display units (310₁, . . . , 310_{n;} 710₁, . . . , 710_{n;} 810₁, . . . , 810ₙ), wherein each display unit is adapted to display an intrinsic display function as well as a video image representing at least one video input;
at least one video distribution unit (320₁, . . . , 320_{p;} 720₁, . . . , 720_{p;} 820₁, . . . , 820ₚ) adapted to switch the video flows generated by said generation devices to the video inputs of said display units.

### TECHNICAL FIELD

This invention relates to the field of aircraft viewing systems.

### STATE OF THE PRIOR TECHNIQUE

The function of traditional type aircraft viewing systems is to present in a simple format information from the on board sensors or systems such as an ADIRS (Air Data Inertial Reference System), an FMS (Flight Management System) or a FQMS (Flight Quantity Management System).

These viewing systems comprise display units equipped with input/output interfaces (buttons, switches, etc.) that allow the desired display mode to be selected. Obtaining the information to be viewed from the elementary data supplied by the on board sensors/systems (for example measurement data) and the composition of the image to be displayed requires calculations which are carried out partially by computers located in the hold of the aeroplane and partially by the display units themselves.

FIG. 1 diagrammatically illustrates the architecture of an aircraft viewing system 100 known in the state of the art. This system is called CDS (Control and Display System). It comprises on the one hand display units 110 located in the cockpit and display computers 120 located in the aircraft hold. These computers are connected to the on board systems and the display units 110 by ARINC 429, ARINC 629 and/or analogue connections.

The computers 120 select the elementary data flows, process this data to obtain the information to be displayed, and transmit this information to the display units.

Each display unit manages its input/output interface and in particular the graphics commands entered by the operator. From these commands and the information received by the computers, it generates the images to be displayed.

In order to provide more flexibility of display and increased interactivity, certain functional systems are now capable of taking charge themselves part of the display function and of transmitting to the display units messages with graphic content which respect a protocol of the highest known level called ARINC 661. The purpose of this protocol is on the one hand to standardise the graphic interface (GUI) of the display units, apart from the on screen visual aspects (look and feel), in an XML type organisation, and on the other hand to standardise the information exchanged with the aircraft's systems. The communication between display units and on board systems uses a switched and deterministic Ethernet network which respects the ARINC 664 standard. Such a network authorises flows of around 10 Mbits/s to 100 Mbits/s.

FIG. 2 diagrammatically illustrates a new generation aircraft viewing system. This system 200 comprises a plurality of display units 210 located in the cockpit, connected to the on board systems of the aeroplane (not shown) by means of an ARINC 664 type network 230, for example a AFDX network (Avionics Full DupleX).

The traditional type aircraft viewing systems are characterised by a relatively summary graphic interface and limited hardware capacities permitting at best to evolve a few simple display functions: new symbology or new parameters to be displayed. They are especially incapable of taking charge of new display functions (new navigational aid, new representation of the failure surveillance system, new representation of the electronic documentation, surveillance of access to the aeroplane, etc.). These new functions would require the use of graphic processors and mass memories with which the display units are generally not equipped. A retrofit of a traditional viewing system implies replacing most of its components. Furthermore, the new equipment has every chance of becoming in turn rapidly obsolete due to its incapacity to integrate functions which will subsequently become available. The problem at the origin of the invention is to propose an architecture for a viewing system that is capable of taking on new display functions without having to renounce the existing display functions, whilst avoiding the replacement of the display units.

### DESCRIPTION OF THE INVENTION

This invention is defined by an aircraft viewing system comprising:
a plurality of generation devices adapted to generate video flows from aircraft data;
a plurality of display units, wherein each display unit is adapted to display an intrinsic display function as well as a video image representing at least one video input;
at least one video distribution unit adapted to switch the video flows generated by said generation devices to the video inputs of said display units.

In one embodiment, at least one generation device comprises an input/output interface, a computing module adapted to supply the graphic information to a video signal generation module from the aircraft data received on the input/output interface, and a video interface adapted to transform said video signal into at least one video flow in a pre-determined format.

The input/output interface preferably complies with the ARINC 429 or ARINC 664 standard.

Similarly, said format preferably complies with the ARINC 818 standard.

Said generation device may also comprise a data base, wherein the computing module thus generates said graphic information from said aircraft data and data stored in said base.

Advantageously, said video distribution unit comprises a first video interface adapted to receive a plurality of video flows, a synchronisation module adapted to synchronise the flows into a same time base downstream or upstream of a processing module of said flows, and a switching module adapted to switch the flows thus processed and synchronised to a plurality of video outputs.

Said processing module is adapted to merge the video flows and/or an image composition by windowing, wherein each window corresponds to a flow or several merged flows.

The processing module is adapted to rotate and/or resize an image.

The aircraft viewing system may also comprise an auxiliary data management unit adapted to extract and/or insert auxiliary data from or into a video signal, wherein said auxiliary data is transported during the line return and/or frame return of said signal, and a control unit adapted to check the integrity of the video flows from data extracted by said management unit.

Said control unit is advantageously adapted to detect erroneous frames in the video flows, to eliminate them and/or replace them immediately with pre-determined or interpolated frames.

In one variant, the switching module is adapted to duplicate at least one of said processed and synchronised flows so as to transmit it to at least two of said video outputs.

Preferably, at least one display unit comprises a video display plane to display the video signal and at least one second display plane, wherein said display unit is adapted to display in a first screen zone said intrinsic display function and in the remaining part of the screen said video image, wherein the video display plane is masked in said first zone by the second display plane.

In a second embodiment, the aircraft system comprises at least one display computer distinct from the display units, wherein said computer is adapted to generate an image representing said intrinsic display function for at least one of said display units.

In a third embodiment, the aircraft viewing system comprises at least one display computer distinct from the display units, wherein said computer is adapted to receive at least one first video flow from said video distribution unit, to generate an image representing said intrinsic display function for at least one given display unit, to generate an image representing said intrinsic display function and said first video flows, wherein said image is transmitted in the form of a second video flows to said given display unit.

Finally, the invention is also defined by an aircraft viewing system according to any of the previous claims.

### BRIEF DESCRIPTION OF THE DRAWINGS

Other features and advantages of the invention will become clearer upon reading a preferred embodiment of the invention made in reference to the attached figures among which:

FIG. 1 shows a first aircraft viewing system known in the state of the art;

FIG. 2 shows a second aircraft viewing system known in the state of the art;

FIG. 3 diagrammatically shows an aircraft viewing system in a first embodiment of the invention;

FIG. 4 diagrammatically shows the structure of a functional system of FIG. 3;

FIG. 5 diagrammatically shows the structure of a video distribution system of FIG. 3;

FIG. 6 shows a display mode of a display unit of FIG. 3;

FIG. 7 diagrammatically shows an aircraft viewing system according to a second embodiment of the invention;

FIG. 8 diagrammatically shows an aircraft viewing system according to a third embodiment of the invention.

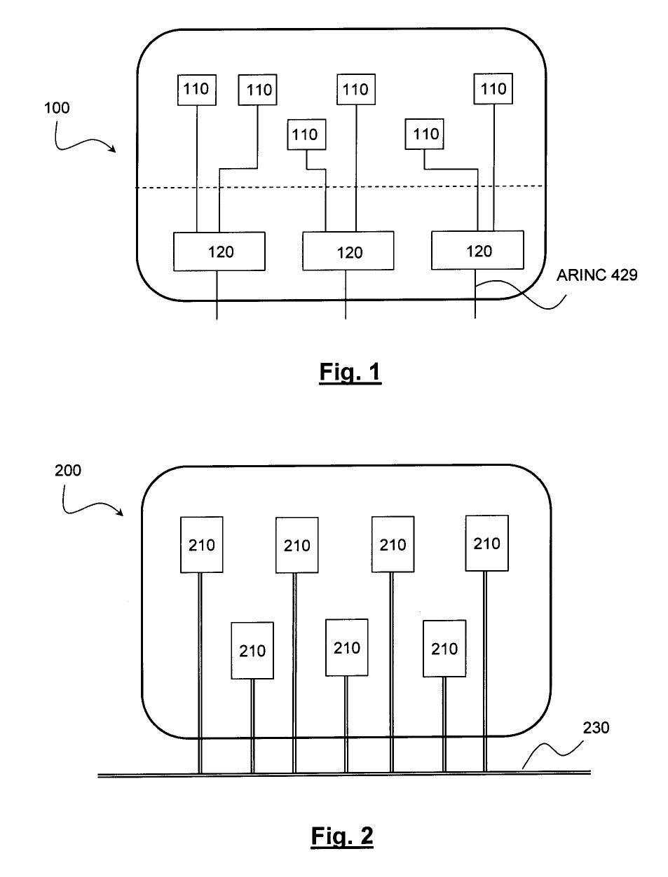

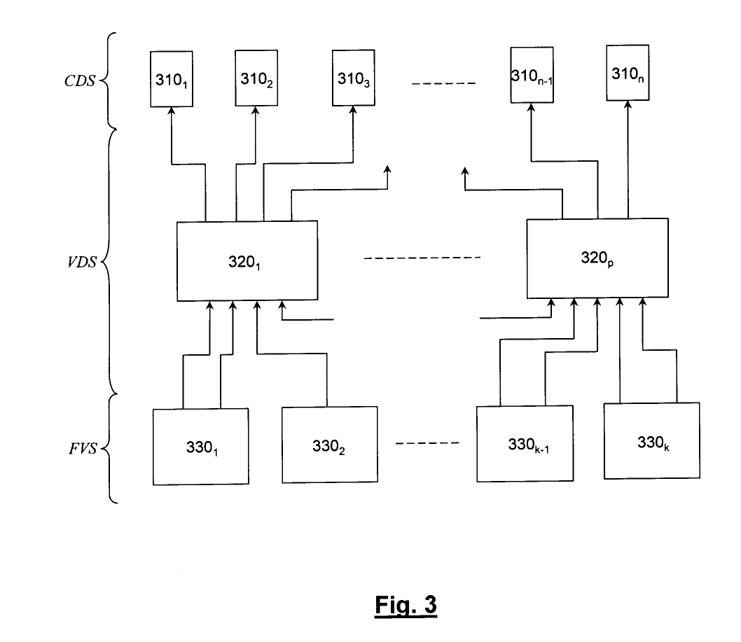

### DETAILED DESCRIPTION OF SPECIFIC EMBODIMENTS

One first general idea upon which the invention is based is to plan that the increase of an existing viewing system by the integration of new display functions is made at the level of the video signal(s) of the display unit. It is therefore possible to upgrade the viewing system in spite of the limited capacities of the display units.

A second general idea upon which the invention is based is to plan a viewing system architecture with three distinct functional layers. The first layer is dedicated to the generation of the video flows, the second layer to the distribution of these flows after possible processing, the third to the display of images obtained from the flows issued from the second layer.

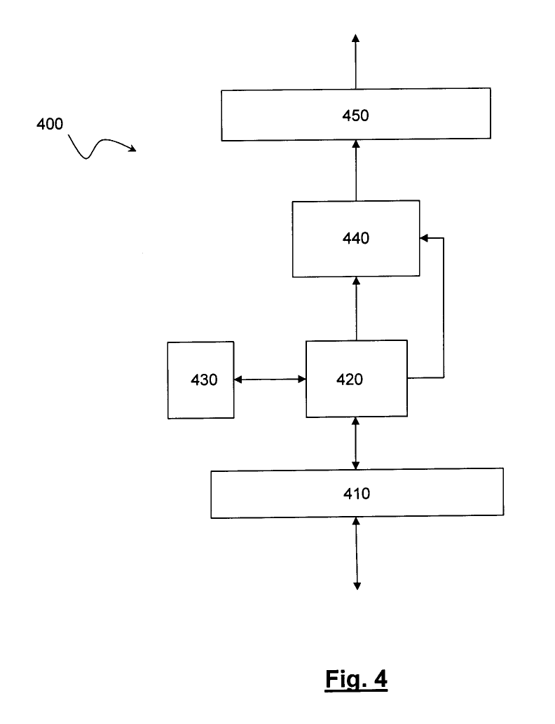

FIG. 3 diagrammatically illustrates an aircraft viewing system according to a first embodiment of the invention.

The first functional layer of the system is referenced FVS (Function Video System). It is composed of a plurality of functional systems 330₁, 330₂, . . . , 330ₖ adapted to acquiring aircraft data from sensors/on board systems etc. and generating from this data a video flow representing a display function. In general, the video flows may be a digital or analogue signal, with separate components, for example RGB, or even a composite signal. Finally, the video flows may possibly be a digital signal compressed using one of the compression formats commonly used MPEG-2, MPEG-4, etc. In all cases, the functional systems are adapted to provide video flows according to a common standard that are able to be decoded by the different display units 310₁, 310₂, . . . , 310ₙ.

The video flows will be advantageously transmitted using optical fibre ANSI FC-AV (Fibre Channel Audio Video), preferably using the communication protocol of the ARINC 818 standard. A description of this standard may be found on the site www.arinc.com.

If the case of a retrofit of an existing infrastructure is envisaged, some of the functional systems 330₁, 330₂, . . . , 330ₖ may be systems already in place, given that they are adapted to generate a video flow. For example, these functional systems may be video sensors or cameras or even systems supplying video flows from these cameras or sensors. The other functional systems are dedicated to the implementation of new additional display functions.

The second functional layer is referenced VDS (Video Distribution System). It is formed by one or several distribution units 320₁, . . . , 320ₚ, wherein each unit can receive several video flows from the functional systems and generate one or several video flows destined for the display units 310₁, 310₂, . . . , 310ₙ. The main function of these distribution units is to switch the different video flows, if applicable, after synchronisation and duplication.

The third functional layer, referenced CDS (Control and Display System), is composed of display units 310₁, 310₂, . . . , 310ₙ. Each display unit has at least one video input and generates from this input, and from intrinsic imaging functions (which is to say independent from the video signal received), an image, or a plurality of images in distinct windows.

In a first specific embodiment, the second layer comprises two distribution units (p=2); one is dedicated to the video flows destined for the display units located in the left side of the cockpit and the other to the video flows destined for the display units located in the right side.

In a second specific embodiment, the second layer comprises, for requirements of redundancy and safety, two identical distribution units, wherein the two units receive the same video flows from the functional systems 330₁, 330₂, . . . , 330ₖ and supply the same video flows intended for the display units 310₁, 310₂, . . . , 310ₙ.

It is obvious to a person skilled in the art that the redundancy requirements may be limited to certain critical display units only, in which case the two units previously mentioned will only supply identical flows to the critical display units and will manage the other display units independently from one another.

The elements of the different functional layers are described in greater detail below.

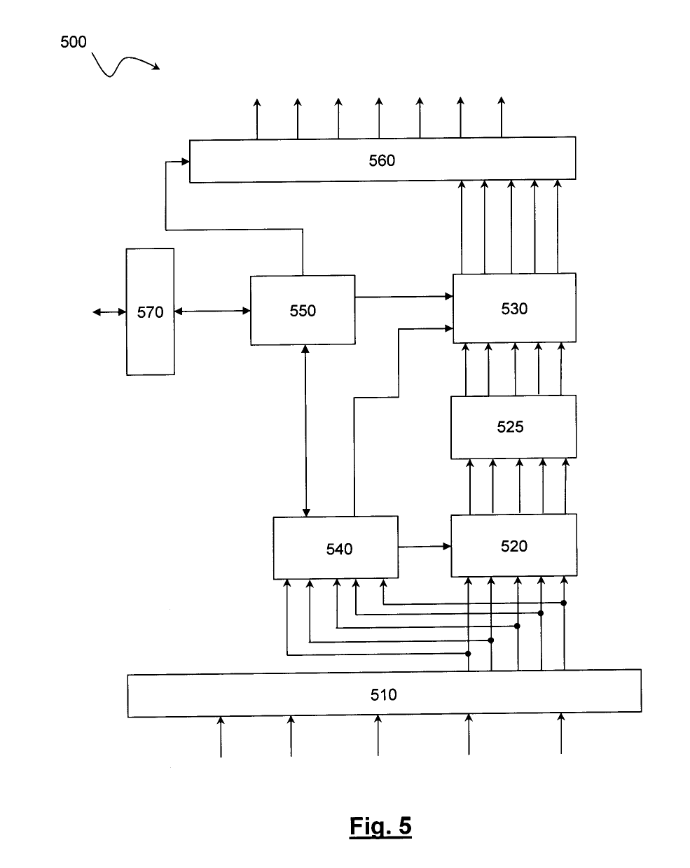

FIG. 4 diagrammatically shows the structure of a functional system such as 330₁, 330₂, . . . , 330ₖ.

In general, a functional system 400 comprises an input/output interface 410 especially adapted to acquire data from on board aircraft systems (IRS, FMS, FQMS etc.) or on board sensors and to transmit the interrogation and/or acceptance messages to these systems/sensors. Preferably the communication between the functional system 400 and the on board systems of the aircraft is provided by ARINC 429 or ARINC 664 connections. The data received is processed by a computing module 420, if applicable, by means of information stored in a data base 430 (for example cartographic data or technical data concerning the aeroplane). The module 420 supplies graphic information from this data to the video generation module 440. A video interface 450 converts the video signal to the format required by the display units. If applicable, the video generation module 440 may generate video signals corresponding to a plurality of images that may be identical or not (for example channels for the pilot and the co-pilot, different viewing angles, stereo view). The input/output interface 410 also permits commands to be received from the display units via an ARINC 429 or ARINC 664 connection. These commands permit in particular the video generation module 440 and the video interface 450 to be configured. Once configured, the video generation module generates a video signal according to the characteristics required (format, interlaced type or not, type of coding, refresh frequency, etc.).

By way of illustration, if the system 400 is an airport navigational aid, it receives position and attitude data from the aeroplane's inertia system. The computing module 420 then recovers in the data base 430 the corresponding map of the airport and determines its position and attitude relative to the map. The video generation module 440 generates a 2D view of the airport as well as a pictogram representing the aeroplane.

FIG. 5 shows a video distribution unit, such as 320₁, . . . , 320ₚ.

The distribution unit 500 receives video flows from a plurality of functional systems via an interface 510.

The incoming video flows are firstly filtered by a video control module 520. This module also receives the CRC of the video frames forming these flows from the auxiliary data management module 540 described below. The video control module verifies the integrity of the frames received by means of the CRC codes. If it detects an erroneous frame it may reject it and, if applicable, replace it immediately with a pre-determined frame or even an interpolated frame.

The video flows are then synchronised by a synchronisation and time adaptation module 525. This module acts as a buffer which permits it to accept flows in a certain range of frame frequency and jitter time, and to align them temporally. If applicable, the frames are interpolated and resynchronised with respect to a clock specific to the distribution layer. The synchronisation module 525 also permits the display units to be protected from the transitory effects related to interruptions and restarts of the video flows (unexpected power cuts, change of configuration of a functional system). To this end, the synchronisation module may emit a video flow “by default” (for example, a test card) when a flow is absent and/or replace frames detected as faulty by default frames (for example, black frames). Alternately, depending on the type of the error detected, the video control module 520 may decide to order the filtering of a frame, to stop the transmission of a flow on the video outputs, to generate a video alarm signal.

The flows thus synchronised are then processed, if applicable, in a processing module 530. The processing may be the merging of several video flows, an image composition by windowing, an image rotation, image resizing, an adaptation of a histogram, etc. The purpose of these processing operations is to make the video flows comply with the characteristics, especially with the geometric characteristics, required by the display units. If applicable, new auxiliary data or auxiliary data regenerated by the management module 540, described below, will be inserted into the flows processed.

It should be noted that, in one variant, the synchronisation module may be positioned downstream of the processing module.

After processing, the flows are switched to the different video output channels by the switching module 560. This module may comprise a replication function, in that an input flow of this module may be transmitted identically to several video outputs. The switching function permits each display unit to receive the corresponding video flow(s) either at a nominal configuration of the display unit or at a configuration selected by the operator, or even at a minimum configuration in the event of a breakdown. Advantageously, in the event of a change of configuration, the interruption of the video flows in progress and the restart on the subsequent flows occurs respectively at the end and at the beginning of a frame. If required, a certain number of intermediate frames may be inserted immediately between these two events, so as to ensure the continuity of the video signal.

In one variant, the distribution unit 500 comprises an auxiliary data management module 540, for example metadata, classically transported with the video signal during the line return or frame return (horizontal and vertical blanking). These auxiliary data generally provide information concerning the frames to which they are attached, such as the generation date, CRC, the parameters used to make the images, content, index, etc. Some of these auxiliary data (especially CRC) are transmitted to the video control module 520 to check the integrity of the frames, the coherency of their succession and the identity of the incident flow. The auxiliary data management module 540 may moreover regenerate in the outgoing flows certain auxiliary data initially present in the incoming flows, or even generate new auxiliary data in the outgoing flows. This generated or regenerated data is transmitted to the processing module 530 for insertion into these flows.

The distribution unit 500 also comprises an input/output interface 570 connected to a ARINC 429 or ARINC 664 communication bus. Consequently, this unit may receive parameters concerning the configuration of the display units and, if applicable, functional systems.

Finally, the distribution unit 500 comprises a processor 550 that manages the configuration of the different modules, especially the processing module 530 and the switching module 560. This processor is also connected to the input/output interface 570 and the auxiliary data management module 540.

The third level of the viewing system is made up of the display units 310₁, 310₂, . . . , 310ₙ. These display units preferably use LCD screens permitting individual control of the luminance and chrominance of each pixel at each refresh cycle of the screen. They generally authorise the display of a symbology (alphanumeric characters, simple geometrical forms), 2D or 3D synthesis images, vectorial or matricial images, and images from a video source.

Advantageously, the display units manage the display from superposed display planes, wherein each plane is attributed a specific level of priority. For example, a plane is dedicated to the symbology, at least one other plane is dedicated to a matricial type also called “bitmap” image and a third plane is dedicated to a video signal. The symbology plane generally has the highest priority followed by that/those of the bitmap plane(s) and finally the priority of the video plane.

For the retrofit of a viewing system, the display functions at the symbology plane and bitmap plane levels are conserved. In other words, the display unit conserves its intrinsic display functions, wherein the retrofit by adding additional display functions is made by means of the video signal.

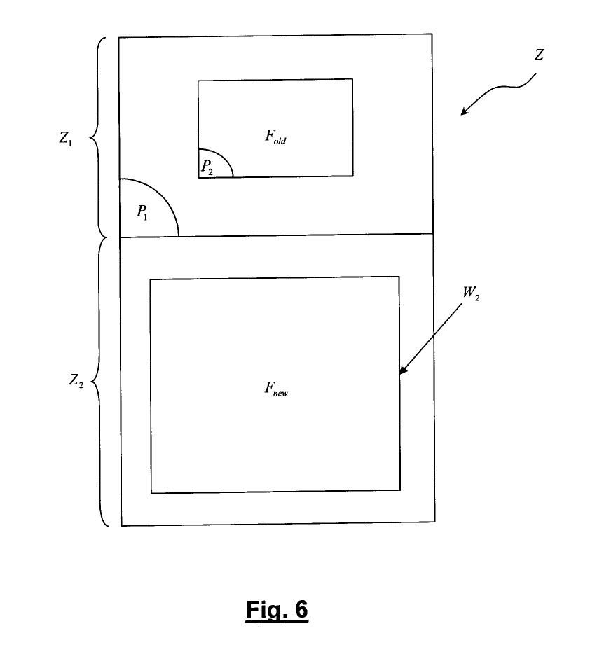

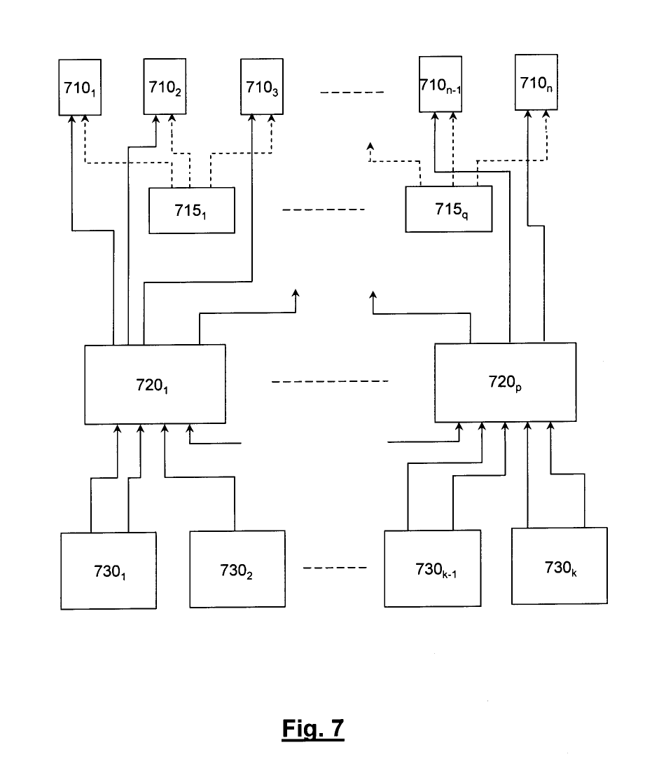

In one first variant, the intrinsic display function(s) and the additional display function(s) are spatially separated on the screen, in other words part of the screen is dedicated to the presentation of the intrinsic display functions and another part is dedicated to the presentation of the additional display functions. This variant is illustrated in FIG. 6. The screen Z is divided into two display zones Z₁ and Z₂, the first is consecrated to the intrinsic functions F_{old} and the second to the additional functions F_{new}. The video plane corresponds to the entire zone Z but its upper part is masked is by a bitmap plane P₁ covering the zone Z₁. The functions F_{old} are displayed by means of a bitmap plane P₂ whose priority is greater than that of the plane P₁ or by means of the symbology plane. The functions F_{new}, only appear in the remaining part Z₂; the functional systems and video distribution units are adapted to supply this display unit a video image in which F_{new} appears in a window W₂ included in Z₂.

In one second variant not illustrated, the display unit has several display blocks, of which one is dedicated to the video input. The latter may have a position/size that is fixed or whose parameters may be set on the screen. Furthermore, the display unit may have a plurality of such display blocks and a plurality of video inputs, for each video input corresponding to a dedicated block on the screen. The distribution system is then adapted to generate, for the display unit in question, different video flows corresponding to images whose sizes correspond to those of the blocks.

In one third variant, the additional display functions F_{new} are not spatially separated from the intrinsic function F_{old}, wherein the latter use a symbology plane or a bitmap plane which is simply superposed onto the video plane.

FIG. 7 illustrates an aircraft viewing system in a second embodiment of the invention.

This embodiment is distinguished from the first in that the calculations required for the implementation of the intrinsic display functions are made by computers outside of the display units, still called display computers. Such display units are called dumb in opposition to the smart display units which have the ability to make these calculations themselves. When the calculations are made partially by the display unit and partially by a display computer, then this is known as a semi-dumb display unit.

In this case, the dumb display units 710₁, 710₂, . . . , 710ₙ receive video flows from the display computers 715₁, . . . , 715_{q} to create their respective intrinsic display functions. Furthermore, certain passive display units receive video flows provided by the video distribution units 720₁, . . . , 720ₚ from the flows generated by the functional systems 730₁, 730₂, . . . , 730ₖ. The mix between the intrinsic display functions and additional display functions is made by the display units.

The video distribution units 720₁, . . . , 720ₚ are identical to those 320₁, . . . , 320ₚ of the first embodiment. Similarly, the functional systems 730₁, 730₂, . . . , 730ₖ are identical to those 330₁, 330₂, . . . , 330ₖ of the first embodiment.

The second embodiment may also be realised as the three variants previously mentioned.

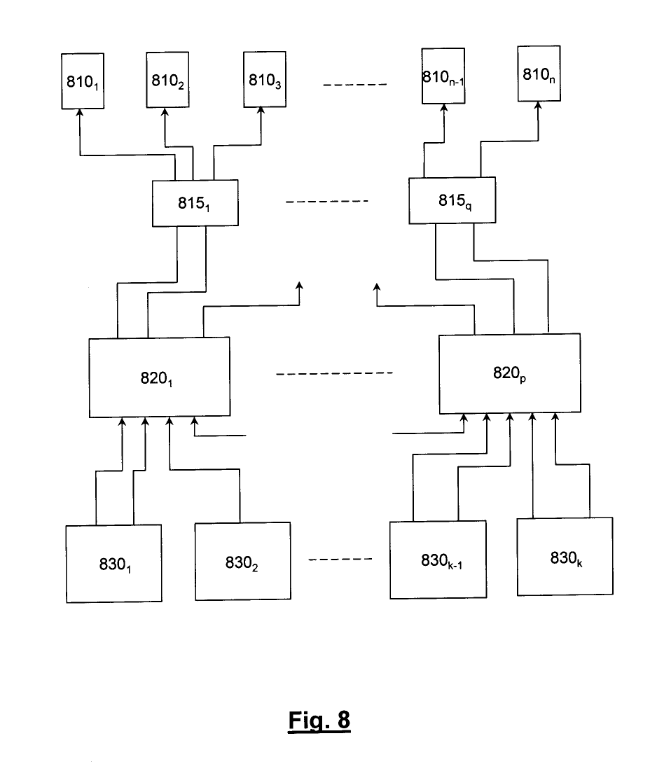

FIG. 8 illustrates an aircraft viewing system according to a third embodiment of the invention.

As in the second embodiment, the display units 810₁, 810₂, . . . , 810ₙ here are of the dumb type. However, differently from the second mode, the display computers 815₁, . . . , 815_{q} receive the video flows supplied by the video distribution units 820₁, . . . , 820ₚ from the flows generated by the functional systems 830₁, 830₂, . . . , 830ₖ. The mix between the intrinsic display functions and the additional display functions is here made by the display computers.

As previously seen, the video distribution units 820₁, . . . , 820ₚ are identical to those 320₁, . . . , 320ₚ of the first embodiment and the functional systems 830₁, 830₂, . . . , 830ₖ are identical to those 330₁, 330₂, . . . , 330ₖ of the first embodiment.

The third embodiment may also be declined into the three variants previously mentioned.

Moreover, the person skilled in the art will understand that the three embodiments described may be combined two by two or all three, especially to upgrade an assembly composed of smart display units and dumb display units.

1. Aircraft viewing system, characterised in that it comprises:
a plurality of generation devices (330₁, . . . , 330_{k;} 730₁, . . . , 730_{k;} 830₁, . . . , 830ₖ) adapted to generate video flows from aircraft data;
a plurality of display units (310₁, . . . , 310_{n;} 710₁, . . . , 710_{n;} 810₁, . . . , 810ₙ), wherein each display unit is adapted to display an intrinsic display function as well as a video image representing at least one video input;
at least one video distribution unit (320₁, . . . , 320_{p;} 720₁, . . . , 720_{p;} 820₁, . . . , 820ₚ) adapted to switch the video flows generated by said generation devices to the video inputs of said display units.

2. Aircraft viewing system according to claim 1, characterised in that at least one generation device (400) comprises an input/output interface (410), a computing module (420) adapted to supply graphic information to a video signal generation module (440) from aircraft data received on the input/output interface, and a video interface (450) adapted to transform said video signal into at least one video flow in a pre-determined format.

3. Aircraft viewing system according to claim 2, characterised in that the input/output interface complies with the ARINC 429 or ARINC 664 standard.

4. Aircraft viewing system according to claim 2 or 3, characterised in that said format complies with the ARINC 818 standard.

5. Aircraft viewing system according to any of claims 2 to 4, characterised in that said generation device (400) further comprises a database (430), wherein the computing module generates said graphic information from said aircraft data and data stored in said database.

6. Aircraft viewing system according to claim 1, characterised in that said video distribution unit (500) comprises a first video interface (510) adapted to receive a plurality of video flows, a synchronisation module (525) adapted to synchronise the flows in a same temporal base downstream or upstream of a processing module (530) of said flows, and a switching module adapted to switch the flows thus processed and synchronised to a plurality of video outputs.

7. Aircraft viewing system according to claim 6, characterised in that said processing module (530) is adapted to merge video flows and/or a composition of images by windowing, wherein each window corresponds to a flow or several merged flows.

8. Aircraft viewing system according to claim 6 or 7, characterised in that the processing module (530) is adapted to rotate and/or resize images.

9. Aircraft viewing system according to claim 6, characterised in that it comprises an auxiliary data management unit (540) adapted to extract and/or insert auxiliary data from or into a video signal, wherein said auxiliary data is transported during the line return and/or frame return of said signal, and a control unit (520) adapted to check the integrity of the video flows from the data extracted by said management unit (540).

10. Aircraft viewing system according to claim 9, characterised in that said control unit (520) is adapted to detect erroneous frames in the video flows, to eliminate and/or replace them on the fly by pre-determined or interpolated frames.

11. Aircraft viewing system according to claim 6, characterised in that the switching module (560) is adapted to duplicate at least one of said processed and synchronised flows to transmit it to at least two of said video outputs.

12. Aircraft viewing system according to claim 1, characterised in that at least one display unit comprises a video display plane to display the video signal and at least one second display plane (P₁), wherein said display unit is adapted to display in a first screen zone (Z₁) said intrinsic display function (F_{old}) and in the remaining part of the screen said video image (F_{new}), wherein the video display plane is masked in said first zone by the second display plane.

13. Aircraft viewing system according to any of the previous claims, characterised in that it comprises at least one display computer (715₁, . . . , 715_{q}) distinct from the display units, wherein said computer is adapted to generate an image representing said intrinsic display function for at least one said display units.

14. Aircraft viewing system according to any of claims 1 to 12, characterised in that it comprises at least one display computer (815₁, . . . , 815_{q}) distinct from the display units, wherein said computer is adapted to receive at least one first video flow from said video distribution unit, to generate an image representing said intrinsic display function for at least one given display unit, to generate an image representing said intrinsic display function and said first video flow, wherein said image is transmitted in the form of a second video flow to said given display unit.

15. Aircraft characterised in that it comprises an aircraft viewing system according to any of the previous claims.
